(19) United States
(12) Patent Application Publication
(10) Pub. No.: US 2005/0045675 A1
(43) Pub. Date: Mar. 3, 2005

(54) Removable weather protection flaps for child carrier

(76) Inventors: Ed C. Redlinger, Kotzebue, AK (US); Deanne E. Henderson, Kotzebue, AK (US)

Correspondence Address: Richard C. Litman;LITMAN LAW OFFICES, LTD., P.O. Box 15035, Arlington, VA, 22215, US

(21) Appl. No.: 10/924,932

(22) Filed: Aug. 25, 2004

Related U.S. Application Data
(60) Provisional application No. 60/498,364, filed on Aug. 28, 2003.

(51) Int. Cl. A61G 1/00

(52) U.S. Cl. 224/161; 224/160

(57) ABSTRACT

A set of removable weather protection flaps that are used in combination with a child carrier with a foot rail on each side, a hood, two elongated sides, a bottom and a back side. The set of removable weather protection flaps have two symmetrical side flaps with a top portion and a bottom portion that are fitted to cover the two elongated sides of the child carrier. There is also a generally square bottom flap that covers the bottom of the child carrier, the generally square bottom flap having two side edges, the bottom portions being attached to the generally square bottom flap and the top portions are pulled up and secured over the hood of the child carrier.

### CROSS-REFERENCE TO RELATED APPLICATION

This application claims the benefit of U.S. Provisional Patent Application Ser. No. 60/498,364, filed Aug. 28, 2003.

### BACKGROUND OF THE INVENTION

1. Field of the Invention

The present invention relates to child carriers, and more specifically, to removable weather protection flaps that go onto a child carrier.

2. Description of the Related Art

Child carriers or baby backpacks are popular items with parents of babies and young children. They provide much convenience in allowing a parent to carry his or her child while freeing up his or her hands to perform other needed tasks. These child carriers and baby backpacks are well-known in the related art as are devices that can be added onto a child carrier or backpack for protecting babies and young children against the elements when being carried.

U.S. Pat. No. 5,695,100 issued to O'Brien on Dec. 9, 1997, outlines the use of a sunshade device with a baby backpack formed for supporting a baby occupant therein which includes a first mounting bracket coupled to a first portion of the baby backpack, and a second mounting bracket coupled to the second frame portion of the baby backpack. A U-shaped rear shade support includes a rear portion extending upwardly from the backpack having one end coupled to the first mounting bracket and an opposite end is coupled to the second mounting bracket.

U.S. Pat. No. 5,626,271 issued to Messey et al. on May 6, 1997, outlines the use of a child carrier for supporting a child adjacent to the back of a hiker's torso that has a forward portion and a rearward portion. A child compartment is formed between the forward and rearward portions for receiving a child. A generally rigid frame member is operatively connected to and adjacent to the rearward portion of the child carrier. A kickstand having a ground-engageable portion is operatively connected to the frame member via a hinge for pivotal movement of the kickstand relative to the frame member about a horizontal axis.

U.S. Pat. No. 5,934,529 issued to O'Brien on Aug. 10, 1999, outlines a sunshade device for use with a baby backpack formed for supporting a baby occupant, which includes a substantially flexible, resilient rod having an upper light portion and a pair of spaced-apart leg portions. The first leg portion is coupled to the baby backpack proximate one side of the seat support, and an opposite second leg portion of the rod is coupled to the baby backpack proximate an opposite second side of the seat support.

U.S. Pat. No. 6,092,543 issued to Roh on Jul. 25, 2000, outlines the use of a protective cover for a backpack style baby carrier which fully encloses the occupant of the carrier, providing protection from sun exposure, insects, rain, snow and light impact from overhanging branches. The cover may be used while the carrier is being carried and while it is set on the ground. An integral pocket encloses the carrier's collapsible stand, providing for normal use of the stand. Baffled openings are provided for the carrier straps, preventing ingress by insects through the strap openings.

U.S. Pat. No. 6,318,608 issued to Fowler et al. issued on Nov. 20, 2001, outlines the use of a child carrier for supporting a child adjacent to the back of a user's torso which includes a forward portion having straps engageable with the user's torso for enabling the user to tote the child carrier in a hands-free manner. A rearward portion is generally rearward of and spaced from the forward portion and a seat portion is connected generally between the forward and rearward portions for supporting a child.

U.S. Pat. No. 6,434,750 issued to Hunter on Aug. 20, 2002, outlines the use of an apparatus for covering an infant that is placed in a front-worn type of infant carrier which includes a flexible center panel that includes a pair of arcuate sides that curve inward proximate to the vertical center of the center panel. A pair of flexible side panels includes a pair of opposite outwardly curved edges that are each attached on one side to one of the arcuate sides of the center panel.

French Patent FR 2,705,017 granted to Daniel et al. on Nov. 18, 1994, outlines the use of a system that includes a rucksack, making it possible to transport a child or baby weighing up to 20-25 kgs. The rucksack has a frame on which a hinge system is fastened which permits rapid deployment of a safety arch and of a seat, with the straps being securely attached to the frame. The entire system is connected by a cord, which makes it possible, when pulling the seat towards oneself, at the same time to fold down the safety arch and hold it in a horizontal position.

Web site at http://www.babiesexpress.com outlines the sale and use of a rain hood for child carriers.

Web site at http://www.toughtraveler.com outlines the sale and use of a rain and sun hood for child carriers.

Although each of these patents and Web sites outline the use of novel and useful inventions, what is really needed are removable weather protection flaps that can be used with some current models of child carriers and be easily stored within the child carrier when not in use. Such products would be in great demand with parents of young children or babies and would be well-received in the marketplace.

None of the above inventions and patents, taken either singly or in combination, is seen to describe the instant invention as claimed. Thus a child carrier with removable weather protection flaps solving the aforementioned problems is desired.

### SUMMARY OF THE INVENTION

The invention is a set of removable weather protection flaps used in combination with a child carrier with a foot rail on each side, a hood, two elongated sides, a bottom and a backside. The set of removable weather protection flaps have two symmetrical side flaps with a top portion and a bottom portion that are fitted to cover the two elongated sides of the child carrier. There is also a generally square bottom flap that covers the bottom of the child carrier, the generally square bottom flap having two side edges, the bottom portions being attached to the generally square bottom flap and the top portions being pulled up and secured over the hood of the child carrier.

Accordingly, it is a principal object of the invention to provide removable weather protection flaps for use with a child carrier.

It is another object of the invention to provide removable weather protection flaps that can be easily stored within a child carrier.

It is a further object of the invention to provide child carrier weather protection flaps which are breathable and made of lightweight material.

Still another object of the invention is to provide removable weather protection flaps that are easy to put on a child carrier.

It is an object of the invention to provide improved elements and arrangements thereof for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is an environmental, side perspective view of a child carrier with foot rails and a hood.

FIG. 2 is a side perspective view of a child carrier with weather protection flaps according to the present invention.

FIG. 3 is a rear perspective view of a child carrier with weather protection flaps.

FIG. 4 is an exploded perspective view of weather protection flaps used with a child carrier.

Similar reference characters denote corresponding features consistently throughout the attached drawings.

### DETAILED DESCRIPTION OF THE PREFERRED EMBODIMENT

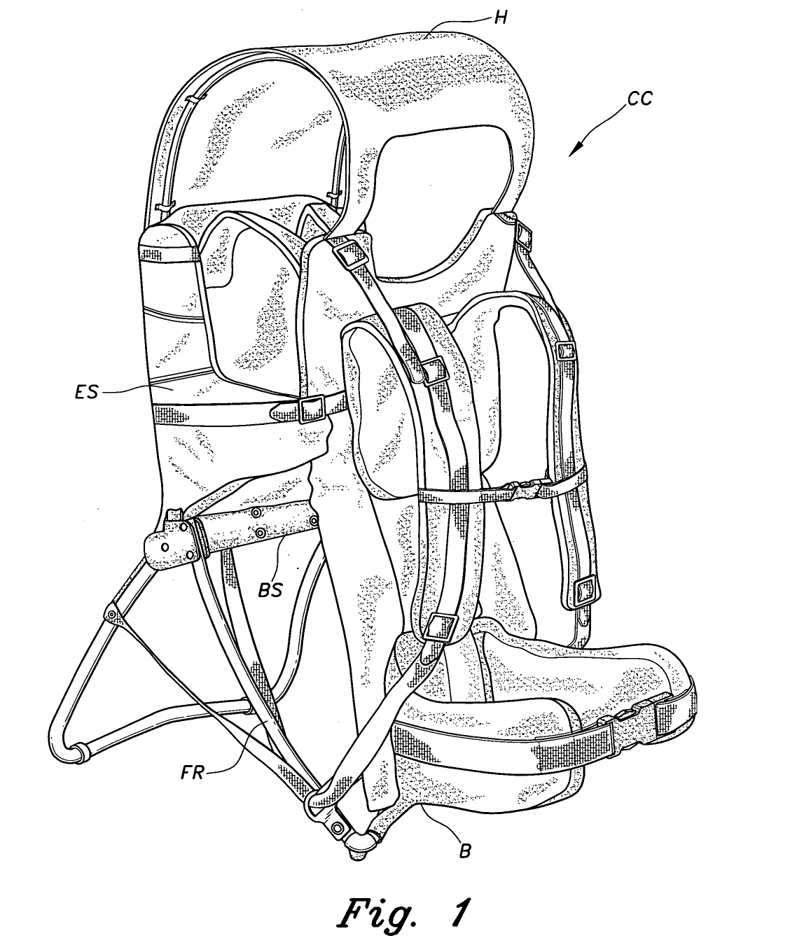

The present invention is a set of removable weather protection flaps 10 used in combination with a child carrier CC with a foot rail FR on each side, a hood H, two elongated sides ES, a bottom B and a back side BS. A depiction of a child carrier CC is provided in FIG. 1. Most typical child carriers CC will have these components, which are well known to those schooled in the related art.

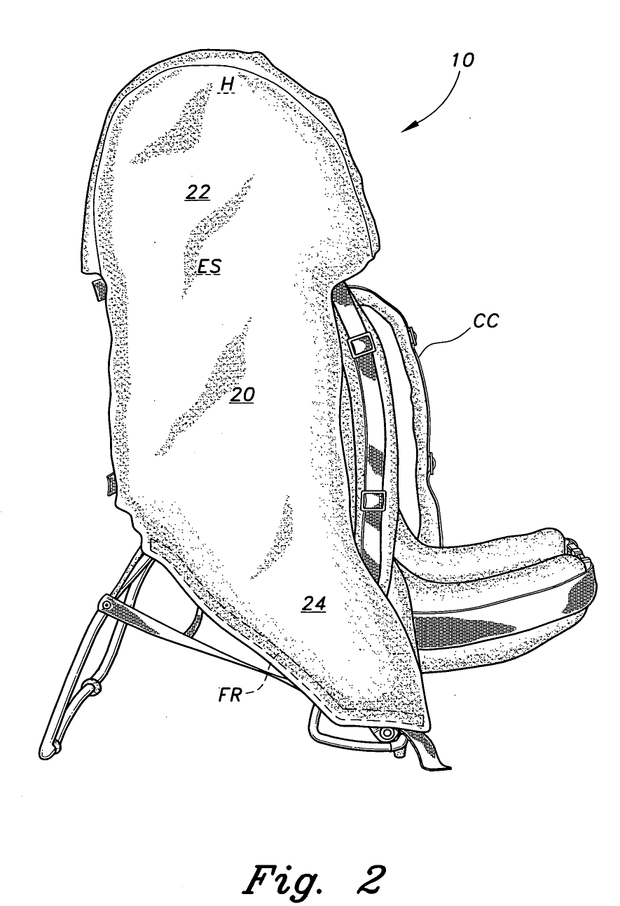

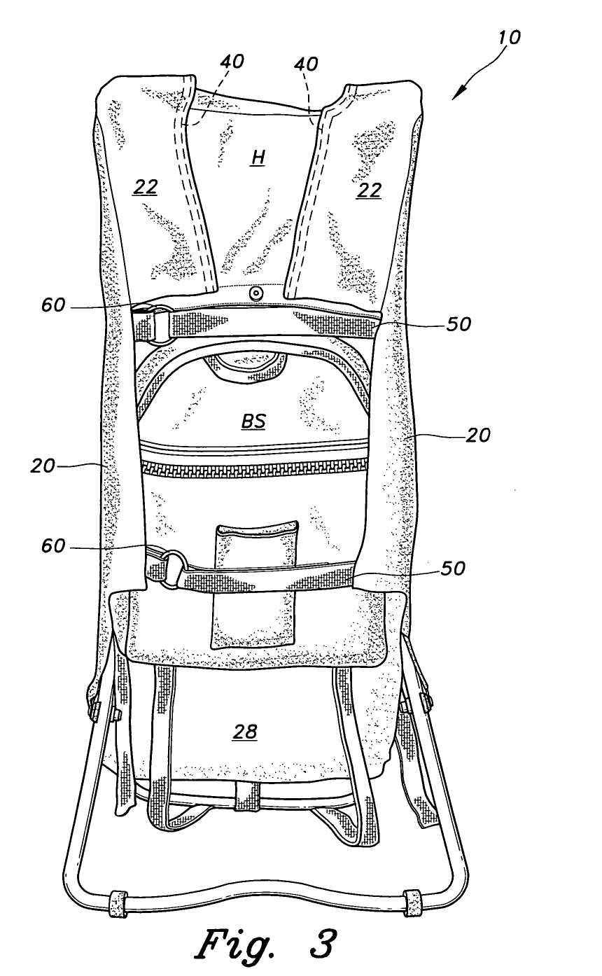

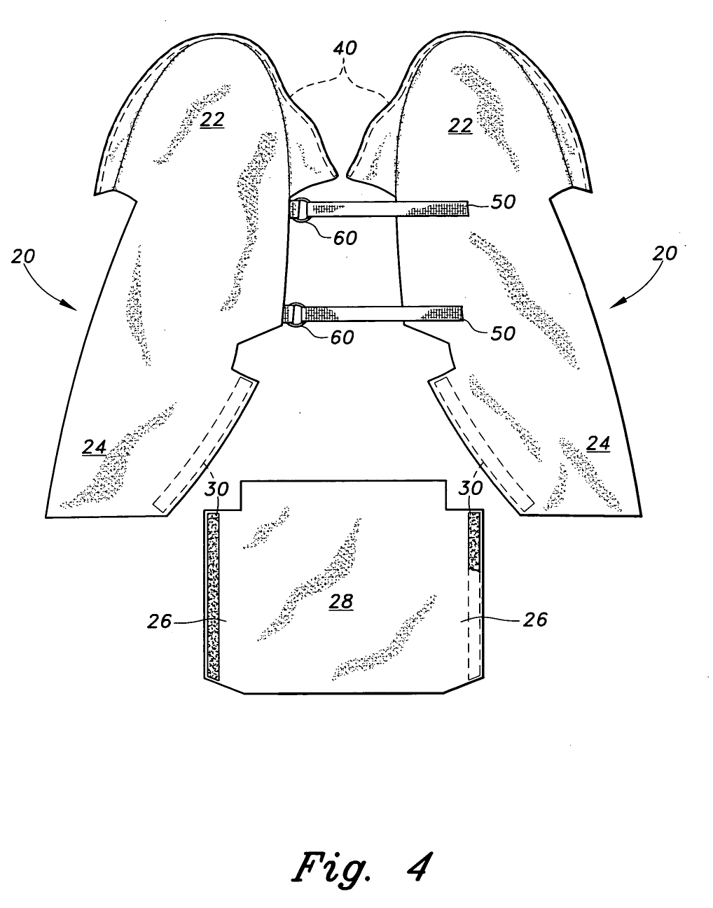

FIG. 2 illustrates a portion of the set of removable weather protection flaps 10 that are used in combination with a child carrier CC. The set of removable weather protection flaps 10 comprise two symmetrical side flaps 20 with a top portion 22 and a bottom portion 24, that are fitted to cover the two elongated sides ES of the child carrier CC. The bottom portion 24 of the symmetrical side flaps 20 each have a side edge (FIG. 4, 26) that wraps around each of the foot rails FR on each elongated side ES and are secured to the bottom portion 24 with a first hook and loop fastener (FIG. 4, 30), which is described in more detail in the Detailed Description for FIG. 4. The top portion 22 of each symmetrical side flap 20 is fitted and is pulled over the hood H of the child carrier CC. Details on an attachment of the top portion 22 to the hood H is described in more detail in the Detailed Description for FIG. 3.

FIG. 3 illustrates how the top portion 22 of each symmetrical side flap 20 is attached to the hood H of the set of removable weather protection flaps 10. The hood H is provided on the child carrier CC and the top portions 22 are pulled up and secured over the hood of the child carrier CC with a second hook and loop fastener 40 located underneath the top portions 22 of the set of removable weather protection flaps 10 and the outside surface of the hood H.

As is also depicted in FIG. 3, the two symmetrical side flaps 20 are attached to each other by a plurality of hook and loop straps 50 and rings 60 that reach across the back side BS of the child carrier CC. The plurality of hook and loop straps 50 are threaded through each of the rings 60 and are folded back and secured on themselves. This plurality of hook and loop straps 50 and rings 60 are well-known to those that are schooled in the related art.

FIG. 4 depicts the entire set of removable weather protection flaps 10. The two symmetrical side flaps 20 are shown attached to each other with the plurality of hook and loop straps 50 and rings 60. The first hook and loop fasteners 30 are located on the bottom portion 24 of the two symmetrical side flaps 20 and the side edges 26 of the generally square bottom flap 28. The set of removable weather protection flaps 10 further comprises the generally square bottom flap 28 that covers the bottom B of the child carrier CC.

Use of the set of removable weather protection flaps 10 is straightforward. The first hook and loop fasteners 30, the second hook and loop fasteners 40 and the plurality of hook and loop straps 50 and rings 60 are all easily manually adjusted. The two symmetrical side flaps 20 and the generally square bottom flap 28 are made of lightweight and breathable material that can be easily stored and folded up in a child carrier CC. The set of removable weather protection flaps 10 are designed to be used with a child carrier CC that has a hood H that includes the second hook and loop fasteners 40 that correspond with the second hook and loop fasteners 40 on the top portion 22 of the two symmetrical side flaps 20.

It is to be understood that the present invention is not limited to the embodiment described above, but encompasses any and all embodiments within the scope of the following claims.

1. A set of removable weather protection flaps for a child carrier, comprising:
two symmetrical side flaps with a top portion and a bottom portion, and that are fitted to cover two elongated sides of the child carrier; and
a generally square bottom flap covering a bottom of the child carrier, said generally square bottom flap having two side edges; whereby
said bottom portions are attached to the generally square bottom flap; and
said top portions are pulled up and-secured over a top of the child carrier.

2. The removable weather protection flaps according to claim 1, there further being a plurality of hook and loop straps and rings, wherein the two symmetrical side flaps are attached to each other by said plurality of hook and loop straps and rings that reach across a back side of the child carrier.

3. The removable weather protection flaps according to claim 1, wherein said two side edges are dimensioned and configured to wrap around foot rails and are secured to the bottom portion of the two symmetrical side flaps.

4. The removable weather protection flaps according to claim 3, there further being additional hook and loop fasteners, wherein the two side edges are secured to the bottom portion of the two symmetrical side flaps with said additional hook and loop fasteners.

5. The removable weather protection flaps according to claim 1, wherein the top portions of the two symmetrical side flaps are dimensioned and configured to be secured with hook and loop fasteners over the top of the child carrier.

6. A set of removable weather protection flaps in combination with a child carrier which has a foot rail on each side, a hood, two elongated sides, a bottom and a back side, comprising:
two symmetrical side flaps with a top portion and a bottom portion fitted to cover the two elongated sides of the child carrier; and
a generally square bottom flap that covers the bottom of the child carrier, said generally square bottom flap having two side edges; whereby
said bottom portions are attached to the generally square bottom flap; and
said top portions are pulled up and secured over the hood of the child carrier.

7. The removable weather protection flaps according to claim 6, there further being a plurality of hook and loop fasteners, wherein the two symmetrical side flaps are attached to each other by said plurality of hook and loop straps and rings that reach across the back side of the child carrier.

8. The removable weather protection flaps according to claim 6, wherein said two side edges are dimensioned and configured to wrap around each of the foot rails and are secured to the bottom portion of the two symmetrical side flaps.

9. The removable weather protection flaps according to claim 8, there further being additional hook and loop fasteners, wherein the two side edges are secured to the bottom portion of the two symmetrical side flaps with said additional hook and loop fasteners.

10. The removable weather protection flaps according to claim 6, wherein the top portions of the two symmetrical side flaps are dimensioned and configured to be secured with hook and loop fasteners over the hood of the child carrier.
